(19) United States
(12) Patent Application Publication
(10) Pub. No.: US 2018/0010526 A1
(43) Pub. Date: Jan. 11, 2018

(54) PLANT CONTROL APPARATUS, PLANT CONTROL METHOD AND POWER PLANT

(71) Applicant: KABUSHIKI KAISHA TOSHIBA, Minato-ku (JP)

(72) Inventors: Takahiro MORI, Yokohama (JP); Masayuki TOBO, Kawasaki (JP); Kazuna SAWATA, Yokohama (JP)

(73) Assignee: KABUSHIKI KAISHA TOSHIBA, Minato-ku (JP)

(21) Appl. No.: 15/432,312

(22) Filed: Feb. 14, 2017

(30) Foreign Application Priority Data
Jul. 8, 2016 (JP) 2016-136285

(51) Int. Cl. F02C 9/20; H02K 7/18; F01K 7/16; F02C 3/04

(52) U.S. Cl. CPC F02C 9/20; F02C 3/04; H02K 7/1823; F01K 7/165; F05B 2270/80; F05B 2220/602

(57) ABSTRACT

In one embodiment, a plant includes a combustor to burn fuel with oxygen from an inlet guide vane (IGV) to generate a gas for a gas turbine (GT), and a heat recovery steam generator to use an exhaust gas from GT to generate steam for a steam turbine (ST). An apparatus controls an IGV opening degree to a first degree and a GT output value to a value larger than a first value between GT start and ST start. The first value is an output value at which exhaust gas temperature can be kept at a first temperature that depends on ST metal temperature, when the IGV opening degree is the first degree. The apparatus increases the IGV opening degree from the first degree based on steam temperature or the GT output value, while the GT output value is controlled to the value larger than the first value.

### CROSS REFERENCE TO RELATED APPLICATION

This application is based upon and claims the benefit of priority from the prior Japanese Patent Applications No. 2016-136285, filed on Jul. 8, 2016, the entire contents of which are incorporated herein by reference.

### FIELD

Embodiments described herein relate to a plant control apparatus, a plant control method and a power plant.

### BACKGROUND

A combined-cycle power plant generally includes a gas turbine, a heat recovery steam generator and a steam turbine, and performs thermal power generation using energy generated through combustion of fuel. Specifically, the gas turbine is driven by a gas supplied from a combustor that burns the fuel. The heat recovery steam generator generates steam using heat of an exhaust gas discharged from the gas turbine. The steam turbine is driven by the steam (main steam) supplied from the heat recovery steam generator.

### BRIEF DESCRIPTION OF THE DRAWINGS

FIG. 1 is a schematic diagram illustrating a configuration of a power plant in a first embodiment;

FIG. 2 is a flowchart illustrating a plant control method in the first embodiment;

FIG. 3 is a graph for explaining the plant control method in the first embodiment;

FIG. 4 is a graph for explaining a plant control method in a modification of the first embodiment;

FIG. 5 is a schematic diagram illustrating a configuration of a power plant in a second embodiment;

FIG. 6 is a flowchart illustrating a plant control method in the second embodiment;

FIG. 7 is a graph for explaining the plant control method in the second embodiment;

FIG. 8 is a schematic diagram illustrating a configuration of a power plant in a first comparative example;

FIG. 9 is a cross-sectional view illustrating a structure of a steam turbine in the first comparative example;

FIG. 10 is a flowchart illustrating a plant control method in the first comparative example;

FIG. 11 is a graph for explaining the plant control method in the first comparative example; and

FIG. 12 is a graph for explaining a plant control method in a second comparative example.

### DETAILED DESCRIPTION

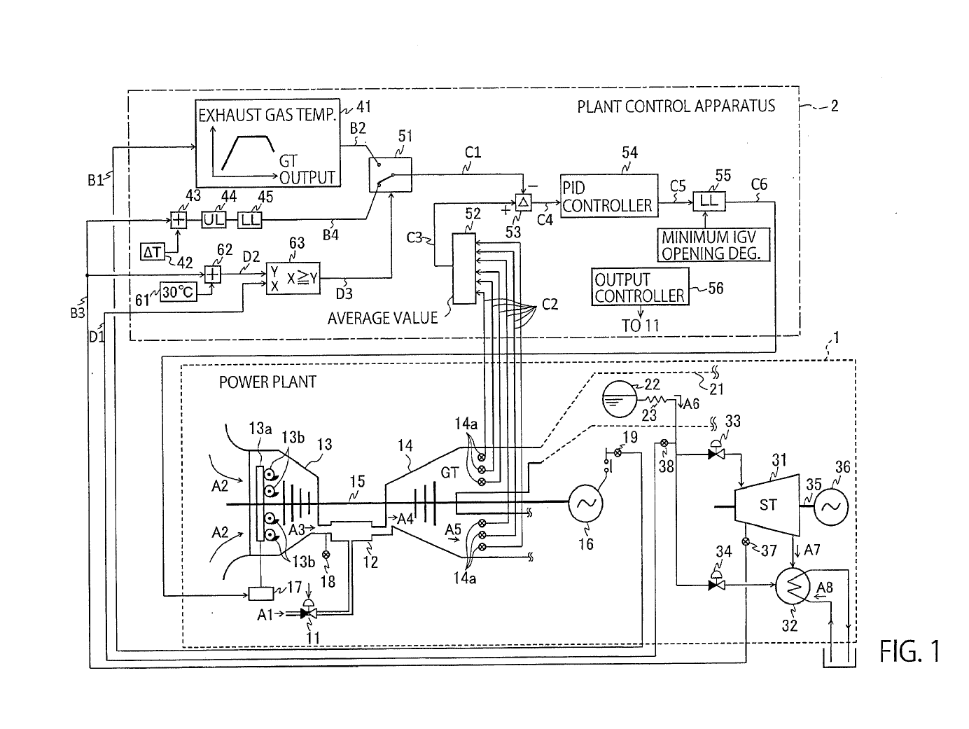

Embodiments and comparative examples thereof will now be explained with reference to the accompanying drawings. In FIGS. 1 to 12, the same or similar configurations are denoted by the same reference characters and the duplicated description thereof will not be made.

Since the heat recovery steam generator generally has a large heat capacity, it takes long time to increase a main steam temperature to a predetermined temperature. However, the thermal power generation is often given a role of an emergency power source, and therefore the combined-cycle power plant is required to have a fast start capability. Accordingly, there is a problem that the delay in increase of the main steam temperature causes an obstruction to the fast start. To solve this problem, it is also desired to employ a technique that enables the fast start while suppressing a harmful influence with the fast start.

In one embodiment, a plant control apparatus is configured to control a power plant that includes a combustor configured to burn fuel with oxygen introduced from an inlet guide vane to generate a gas, a gas turbine configured to be driven by the gas from the combustor, a heat recovery steam generator configured to generate steam using heat of an exhaust gas from the gas turbine, and a steam turbine configured to be driven by the steam from the heat recovery steam generator. The apparatus includes an opening controller configured to control an opening degree of the inlet guide vane to a first opening degree within a period from start of the gas turbine to start of the steam turbine. The apparatus further includes an output controller configured to control an output value of the gas turbine to a value larger than a first output value within the period from the start of the gas turbine to the start of the steam turbine, the first output value being an output value at which a temperature of the exhaust gas can be kept at a first temperature that depends on a metal temperature of the steam turbine, when the opening degree of the inlet guide vane is the first opening degree. The opening controller is configured to increase the opening degree of the inlet guide vane from the first opening degree based on a temperature of the steam or the output value of the gas turbine, while the output controller controls the output value of the gas turbine to the value larger than the first output value.

### First Comparative Example

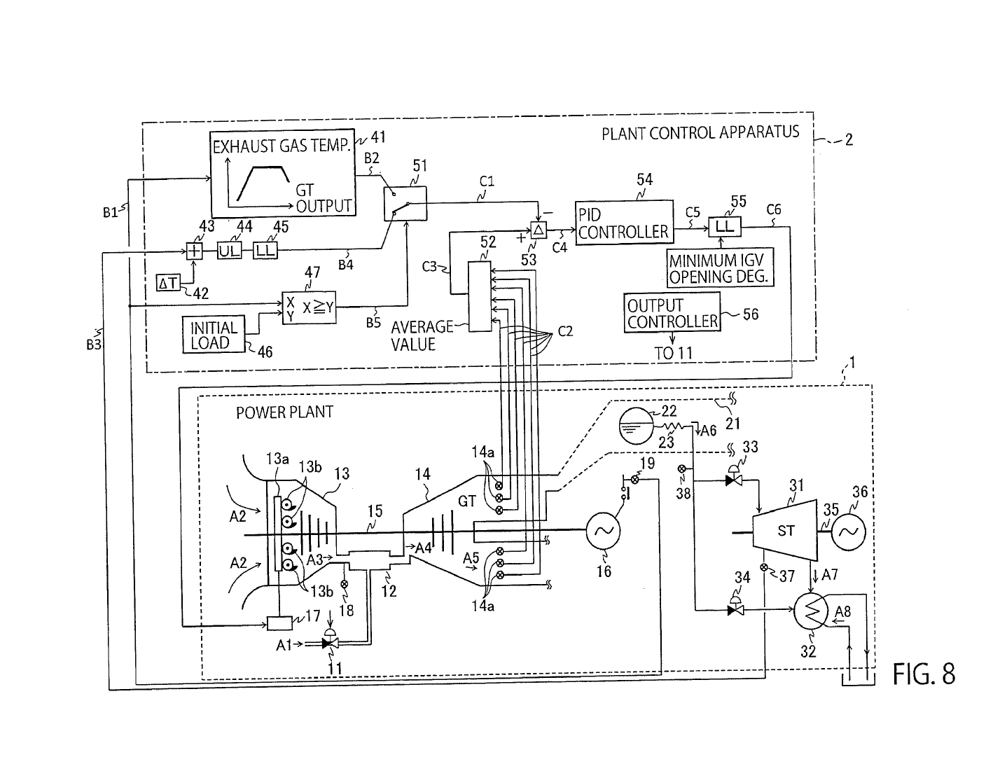

FIG. 8 is a schematic diagram illustrating a configuration of a power plant 1 in a first comparative example. The power plant 1 in this comparative example includes a plant control apparatus 2 that controls the power plant 1. The power plant 1 in this comparative example is a combined-cycle power plant.

The power plant 1 includes a fuel flow control valve 11, a combustor 12, a compressor 13, a gas turbine 14, a gas turbine (GT) rotating shaft 15, a GT power generator 16, a servo valve 17, a compressed air temperature sensor 18, an output sensor 19, a heat recovery steam generator 21, a drum 22, a superheater 23, a steam turbine 31, a condenser 32, a regulating valve 33, a bypass control valve 34, a steam turbine (ST) rotating shaft 35, a ST power generator 36, a metal temperature sensor 37, and a main steam temperature sensor 38. The compressor 13 includes an inlet 13a and a plurality of inlet guide vanes (IGVs) 13b. The gas turbine 14 includes a plurality of exhaust gas temperature sensors 14a.

The plant control apparatus 2 includes a function generator 41, a setter 42, an adder 43, an upper limiter 44, a lower limiter 45, a setter 46, a comparator 47, a switcher 51, an average value operator 52, a subtractor 53, a proportional-integral-derivative (PID) controller 54, and a lower limiter 55. These blocks control the operation of the servo valve 17 so as to function as the opening controller controlling the opening degree of the IGVs 13b. The plant control apparatus 2 further includes an output controller 56 that controls the operation of the fuel flow control valve 11 so as to control the output of the gas turbine 14.

The fuel flow control valve 11 is provided in fuel piping. When the fuel flow control valve 11 is opened, fuel A1 is supplied from the fuel piping to the combustor 12. The compressor 13 includes the IGVs 13b provided at the inlet 13a. The compressor 13 introduces air A2 from the inlet 13a through the IGVs 13b to supply compressed air A3 to the combustor 12. The combustor 12 burns the fuel A1 with oxygen in the compressed air A3 to generate a combustion gas A4 at high temperature and high pressure.

The gas turbine 14 is driven rotationally by the combustion gas A4 to rotate the GT rotating shaft 15. The GT power generator 16 is connected to the GT rotating shaft 15 and generates electric power by means of the rotation of the GT rotating shaft 15. An exhaust gas A5 discharged from the gas turbine 14 is delivered to the heat recovery steam generator 21. Each exhaust gas temperature sensor 14a detects the temperature of the exhaust gas A5 at the vicinity of the outlet of the gas turbine 14 and outputs the result of detecting the temperature to the plant control apparatus 2. The heat recovery steam generator 21 generates steam by means of the heat of the exhaust gas A5, which will be described later.

The servo valve 17 is used to adjust the opening degree of the IGVs 13b. The compressed air temperature sensor 18 detects the temperature of the compressed air A3 at the vicinity of the outlet of the compressor 13 and outputs the result of detecting the temperature to the plant control apparatus 2. The output sensor 19 detects the output of the gas turbine 14 and outputs the result of detecting the output to the plant control apparatus 2. The output of the gas turbine 14 is electricity output of the GT power generator 16 connected to the gas turbine 14. The output sensor 19 is provided in the GT power generator 16.

The drum 22 and the superheater 23 are provided in the heat recovery steam generator 21, constituting part of the heat recovery steam generator 21. Water in the drum 22 is delivered to an evaporator (not illustrated) and heated by the exhaust gas A5 in the evaporator to turn into saturated steam. The saturated steam is delivered to the superheater 23 and superheated by the exhaust gas A5 in the superheater 23 to turn into superheater steam A6. The superheater steam A6 generated by the heat recovery steam generator 21 is discharged to steam piping. Hereafter, this superheater steam A6 is referred to as main steam.

The steam piping is branched into main piping and bypass piping. The main piping is connected to the steam turbine 31, and the bypass piping is connected to the condenser 32. The regulating valve 33 is provided in the main piping. The bypass control valve 34 is provided in the bypass piping.

When the regulating valve 33 is opened, main steam A6 in the main piping is supplied to the steam turbine 31. The steam turbine 31 is driven rotationally by the main steam A6 to rotate the ST rotating shaft 35. The ST power generator 36 is connected to the ST rotating shaft 35 and generates electric power by means of the rotation of the ST rotating shaft 35. Main steam A7 discharged from the steam turbine 31 is delivered to the condenser 32.

Meanwhile, when the bypass control valve 34 is opened, the main steam A6 in the bypass piping bypassing the steam turbine 31 and is delivered to the condenser 32. The condenser 32 cools the main steam A6 and main steam A7 using circulating water A8 to condense the main steams A6 and A7 into water. In the case where the circulating water A8 is seawater, the circulating water A8 discharged from the condenser 32 is returned to the sea.

The metal temperature sensor 37 detects the metal temperature of a first stage inner surface of the steam turbine 31 and outputs the result of detecting the temperature to the plant control apparatus 2. The main steam temperature sensor 38 detects the temperature of the main steam A6 at the vicinity of a main steam flow outlet of the heat recovery steam generator 21 and outputs the result of detecting the temperature to the plant control apparatus 2.

The temperature of the exhaust gas A5 can be controlled by adjusting the amount of supply of the fuel A1 or the flow rate of the air A2. Description will be made below in detail about the amount of supply of the fuel A1 and the flow rate of the air A2.

The amount of supply of the fuel A1 is controlled by controlling the opening degree of the fuel flow control valve 11. The output controller 56 in the plant control apparatus 2 outputs a valve control command signal for controlling the opening degree of the fuel flow control valve 11 to adjust the amount of supply of the fuel A1. For example, when the amount of supply of the fuel A1 increases, the temperature of the combustion gas A4 decreases, the output value of the gas turbine 14 decreases, and the temperature of the exhaust gas A5 decreases. On the other hand, when the amount of supply of the fuel A1 decreases, the temperature of the combustion gas A4 increases, the output value of the gas turbine 14 increases, and the temperature of the exhaust gas A5 increases. As seen from the above, the output controller 56 can control the opening degree of the fuel flow control valve 11, so as to control the output value of the gas turbine 14, and thereby can control the temperature of the exhaust gas A5.

The flow rate of the air A2 is adjusted by controlling the opening degree of the IGVs 13b. As with the opening degree of the fuel flow control valve 11, the opening degree of the IGVs 13b is controlled by the plant control apparatus 2. The compressor 13 sucks the air A2 through the IGVs 13b and compresses the air A2 to generate the compressed air A3. For example, when the opening degree of the IGVs 13b increases, the flow rate of the air A2 increases, and the flow rate of the compressed air A3 increases. At this point, the temperature of the compressed air A3 is made higher than the original temperature of the air A2 (substantially an atmospheric temperature) through a compression process, whereas very low as compared with the temperature of the combustion gas A4. As a result, when the opening degree of the IGVs 13b increases, the influence of the compressed air A3 increases, the temperature of the combustion gas A4 decreases, and the temperature of the exhaust gas A5 decreases. On the other hand, when the opening degree of the IGVs 13b decreases, the influence of the compressed air A3 decreases, the temperature of the combustion gas A4 increases, and the temperature of the exhaust gas A5 increases. As seen from the above, controlling the opening degree of the IGVs 13b, the plant control apparatus 2 can control the temperature of the exhaust gas A5. In the case of intending to change the opening degree of the IGVs 13b while keeping the amount of supply of the fuel A1 constant, the output value of the gas turbine 14 changes little.

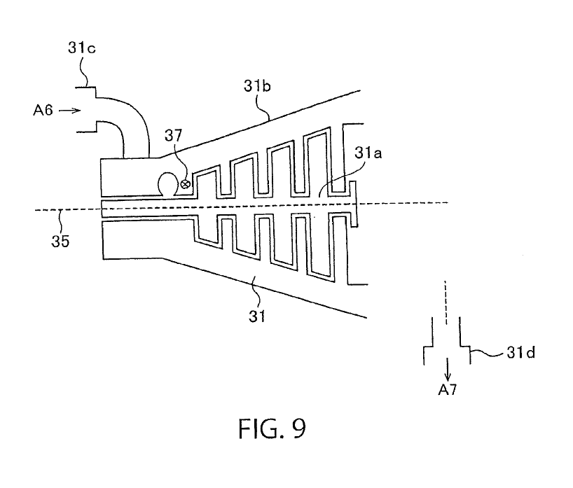

FIG. 9 is a cross-sectional view illustrating a structure of the steam turbine 31 in the first comparative example.

The steam turbine 31 includes a rotor 31a including a plurality of rotor blades, a stator 31b including a plurality of stator vanes, a steam flow inlet 31c, and a steam flow outlet 31d. The main steam A6 is introduced from the steam flow inlet 31c, passing through the steam turbine 31, and is discharged from the steam flow outlet 31d as the main steam A7.

FIG. 9 illustrates the position where the metal temperature sensor 37 is installed. The metal temperature sensor 37 is installed in the vicinity of the inner surface of a first stage stator vane in the steam turbine 31. Therefore, the metal temperature sensor 37 can detect the metal temperature of the inner surface of the first stage stator vane.

Referring FIG. 8 again, the plant control apparatus 2 will be described below in detail.

The function generator 41 generates a function representing the correlation between the output value of the gas turbine 14 (hereafter, referred to as a GT output value) and the temperature of the exhaust gas A5 in normal time (hereafter, referred to as an exhaust gas temperature). The function generator 41 acquires a measured value B1 of GT output value from the output sensor 19 and outputs a setting value B2 of exhaust gas temperature corresponding to the measured value B1, following a function curve set to the function generator 41.

The function generator 41 may generate a function representing the correlation between the pressure of the compressed air A3 (hereafter, referred to as a compressed air pressure) and an exhaust gas temperature in normal time. In this case, the function generator 41 acquires a measured value of the compressed air pressure and outputs a setting value B2 of exhaust gas temperature corresponding to this measured value.

The setter 42 holds a setting value ΔT for the temperature difference on startup between the exhaust gas temperature and the metal temperature of the first stage inner surface in the steam turbine 31 (hereafter, referred to as a metal temperature). The adder 43 acquires a measured value B3 of metal temperature from the metal temperature sensor 37 and acquires the setting value ΔT from the setter 42. Then, the adder 43 adds the setting value ΔT to the measured value B3 of metal temperature and outputs a setting value B3+ΔT of exhaust gas temperature.

The upper limiter 44 holds an upper limit value UL of the exhaust gas temperature and outputs either the setting value B3+ΔT or the upper limit value UL, whichever is smaller. The lower limiter 45 holds a lower limit value LL of the exhaust gas temperature and outputs either the output of the upper limiter 44 or the lower limit value LL, whichever is larger. Therefore, the lower limiter 45 outputs a middle value of the setting value B3+ΔT, the upper limit value UL, and the lower limit value LL, as a setting value B4 of exhaust gas temperature. This means that the setting value B3+ΔT of exhaust gas temperature is limited to a value between the upper limit value UL and the lower limit value LL.

The setter 46 holds a setting value for the initial load of GT output value (hereafter, simply referred to as an initial load). The comparator 47 acquires the measured value B1 of GT output value from the output sensor 19 and acquires the initial load of GT output value from the setter 46. Then, the comparator 47 compares the measured value B1 and the initial load and outputs a switching signal B5 corresponding to the result of the comparison.

The switcher 51 acquires the setting value B2 of the exhaust gas temperature in normal time from the function generator 41, acquires the setting value B4 of the exhaust gas temperature on startup from the lower limiter 45, and outputs a setting value C1 of exhaust gas temperature in accordance with the switching signal B5 from the comparator 47.

The indication of the switching signal B5 changes according to whether or not a measured value B1(X) of GT output value increases to an initial load (Y) and reaches the initial load (Y) (X≧Y). Before the measured value B1 reaches the initial load, the switcher 51 keeps the setting value C1 to be the setting value B2 of exhaust gas temperature in normal time. On the other hand, when the measured value B1 reaches the initial load, the switcher 51 switches the setting value C1 to the setting value B4 of exhaust gas temperature on startup. The setting value C1 is used as a setting value (SV value) in PID control. Hereafter, the setting value C1 will also be referred to as the SV value.

The average value operator 52 acquires measured values C2 of exhaust gas temperatures from the different exhaust gas temperature sensors 14a in the gas turbine 14. These exhaust gas temperature sensors 14a are installed along the circumference of a discharge unit of the gas turbine 14. The average value operator 52 calculates and outputs an average value C3 of these measured values C2. The average value C3 is used as a process value (PV value) in PID control. Hereafter, the average value C3 will also be referred to as the PV value.

The subtractor 53 acquires the SV value C1 of exhaust gas temperature from the switcher 51 and acquires the PV value C3 of exhaust gas temperature from the average value operator 52. Then, the subtractor 53 subtracts the SV value C1 from the PV value C3 and outputs a deviation C4 between the SV value C1 of exhaust gas temperature and the PV value C3 (Deviation C4=PV value C3−SV value C1).

The PID controller 54 acquires the deviation C4 from the subtractor 53 and performs PID control to bring the deviation C4 close to zero. An amount of manipulation (an MV value) C5 output from the PID controller 54, the opening degree of the IGVs 13b (hereafter, referred to as an IGV opening degree). When the PID controller 54 changes the MV value C5, the IGV opening degree changes, and the exhaust gas temperature changes. As a result, the PV value C3 of the exhaust gas temperature changes so as to approach the SV value C1.

As seen from the above, the PID controller 54 performs feedback control to control the exhaust gas temperature. Specifically, the PID controller 54 calculates the MV value C5 based on the deviation C4 between the SV value C1 and the PV value C3 of exhaust gas temperature and controls the exhaust gas temperature through the control of the MV value C5.

An excessively small IGV opening degree may impair the combustion in the combustor 12. For this reason, the MV value C5 is input into the lower limiter 55 holding the lower limit value LL (a minimum opening degree) of the IGV opening degree. The lower limiter 55 outputs either the MV value C5 or the lower limit value LL, whichever is larger, as a corrected MV value C6.

The plant control apparatus 2 outputs the MV value C6 to drive the servo valve 17, controlling the IGV opening degree by means of hydraulic working of the servo valve 17. As a result, the IGV opening degree changes in accordance with the MV value C6, and the PV value C3 of the exhaust gas temperature changes so as to approach the SV value C1.

Description will be made below about the difference between the setting value B2 of exhaust gas temperature in normal time and the setting value B4 of exhaust gas temperature on startup.

The setting value B2 of exhaust gas temperature in normal time is used, for example, on startup of the power plant 1 until the main steam temperature satisfies a predetermined condition. Meanwhile, the setting value B4 of exhaust gas temperature on startup is used, for example, on startup of the power plant 1 after the main steam temperature satisfies the predetermined condition.

[Setting Value B2 of Exhaust Gas Temperature in Normal Time]

On startup of the power plant 1, which is of the combined-cycle type, it is desired to increase exhaust gas temperature to facilitate the generation of the main steam A6. For this reason, the function curve of the function generator 41 is generally set so that the exhaust gas temperature becomes a relatively high temperature.

Therefore, when the setting value C1 of exhaust gas temperature is set at the setting value B2 in normal time, the deviation C4 is kept at a negative value, and the MV value C6 of IGV opening degree is kept at the minimum opening degree. That is, immediately after the startup of the power plant 1, the IGV opening degree is kept at the minimum opening degree irrespective of the GT output value. The value of the minimum opening degree is set at, for example, an opening degree ranging between 30% and 50%.

[Setting Value B4 of Exhaust Gas Temperature on Startup]

Meanwhile, the setting value B4 of exhaust gas temperature on startup is used to set the main steam temperature at a temperature suitable for the startup of the steam turbine 31. Specifically, when the measured value B1 of GT output value reaches the initial load, the setting value C1 of exhaust gas temperature is switched from the setting value B2 in normal time to the setting value B4 on startup so as to bring the main steam temperature close to the metal temperature. The setting value B4 is generally given as the sum of the measured value B3 of metal temperature and the setting value ΔT for temperature difference (i.e., exhaust gas temperature=metal temperature+ΔT).

This configuration reduces a mismatch between the main steam temperature and the metal temperature. With this configuration, steam injection into the steam turbine 31 produces the main steam A6 at which a thermal stress occurring in the steam turbine 31 is low, which is preferable. For example, the setting value ΔT is 30° C.

However, if the setting value B4 of exhaust gas temperature has an excessively large or small value causes an inconvenience to the operation of the gas turbine 14 and the heat recovery steam generator 21. For this reason, the setting value B4 is set by limiting the value of the metal temperature+ΔT to the value between the upper limit value UL and the lower limit value LL.

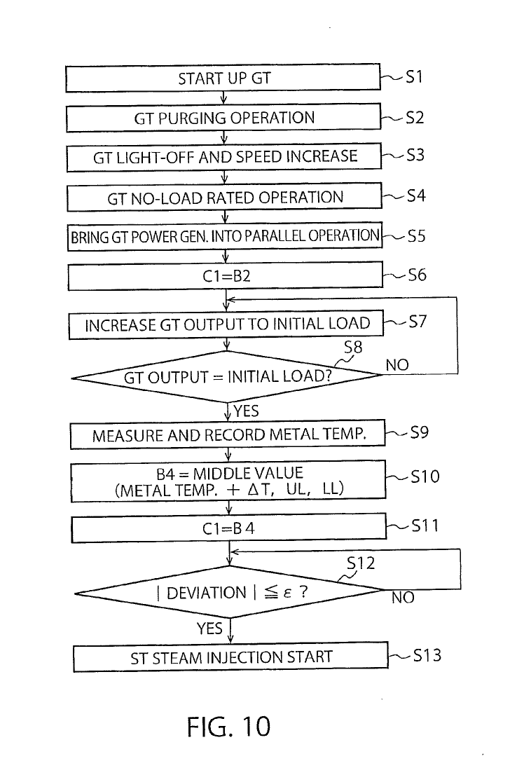

FIG. 10 is a flowchart illustrating a plant control method in the first comparative example.

The plant control method illustrated in FIG. 10 is executed on startup of the power plant 1 by the plant control apparatus 2. In the present method, it is assumed to perform cold start before which the operation of the power plant 1 has been suspended for a long time, and the metal temperature has been lowered to a low-temperature state.

When the gas turbine 14 is started up (step S1), and the gas turbine 14 is subjected to purging operation (step S2). Next, light-off of the gas turbine 14 is carried out, and the speed of the gas turbine 14 increases (step S3), whereby the gas turbine 14 is brought into no-load rated operation (step S4).

Next, the GT power generator 16 is brought into parallel operation (step S5), and thereafter, the plant control apparatus 2 sets the setting value (SV value) C1 of exhaust gas temperature at the setting value B2 in normal time (step S6). As a result, the MV value C6 of IGV opening degree is kept at the minimum opening degree. In addition, in order to avoid the disturbance of reverse power that the GT power generator 16 may suffer immediately after being brought into the parallel operation, the plant control apparatus 2 immediately increases the GT output value to the initial load (steps S7 and S8). Next, when the GT output value reaches the initial load, the plant control apparatus 2 acquires and stores the measured value B3 of metal temperature from the metal temperature sensor 37 (step S9).

Next, the plant control apparatus 2 uses the measured value B3 stored in step S9 to calculate the setting value B4 of exhaust gas temperature (=B3+ΔT). The gas turbine 14 cannot operate at extremely high or low exhaust gas temperatures, and therefore the limits, the upper limit value UL and the lower limit value LL, are imposed on the setting value B4. Specifically, the setting value B4 is set at a middle value of B3+ΔT, UL, and LL (step S10).

Until the GT output value increases to the initial load, the SV value C1 of exhaust gas temperature is set at the setting value B2 in normal time, and the exhaust gas A5 has a relatively high temperature. On the other hand, when the GT output value increases to the initial load, the SV value C1 of exhaust gas temperature is switched to the setting value B4 on startup (step S11).

Since cold start is performed in the present method, the measured value B3 of metal temperature is a low temperature. For this reason, B3+ΔT is also a low temperature, and therefore the setting value B4 often assumes the lower limit value LL. Therefore, the SV value C1 of exhaust gas temperature is a low temperature, and the deviation C4 is a positive value. As a result, the MV value C6 of IGV opening degree increases from the minimum opening degree, and the PV value C3 of exhaust gas temperature decreases from the setting value B2 to the setting value B4.

Continuing the initial load operation of the gas turbine 14 while keeping the exhaust gas temperature at the setting value B4 causes the main steam temperature to gradually increase with time to asymptotically approach the metal temperature. Therefore, the plant control apparatus 2 acquires the measured value of the main steam temperature from the main steam temperature sensor 38 and calculates the deviation between the measured value of the main steam temperature and the measured value B3 of the metal temperature. Furthermore, the plant control apparatus 2 determines whether or not the absolute value of the deviation is equal to or less than ε (step S12).

Then, when the absolute value of the deviation becomes equal to or less than E, the plant control apparatus 2 opens the regulating valve 33 to start the steam injection of the steam turbine 31 (step S13). The steam turbine 31 is started up in such a manner. On the other hand, when the absolute value of the deviation becomes larger than ε, the plant control apparatus 2 puts itself on standby for starting the steam injection of the steam turbine 31.

Afterward, in the present method, the startup process of the power plant 1 is continued.

On the steam turbine 31, an increase of the speed of the steam turbine 31, the parallel operation of the ST power generator 36, an increase of the output of the steam turbine 31 to the initial load, initial load heat soak of the steam turbine 31, and a further increase of the output of the steam turbine 31 are performed in this order.

On the gas turbine 14, at a timing when the thermal stress in the steam turbine 31 is reduced to some extent to calm down, the SV value C1 of the exhaust gas temperature is switched again from the setting value B4 on startup to the setting value B2 in normal time. Then, an increase of the output of the gas turbine 14 from the initial load is started.

At the end of the startup process of the power plant 1, the output of the gas turbine 14 reaches a maximum output (base load) allowed under an atmospheric temperature condition on startup. From the exhaust gas A5 of the gas turbine 14 at the maximum output, the heat recovery steam generator 21 generates the main steam A6, which drives the steam turbine 31, causing the output thereof to reach a rated output.

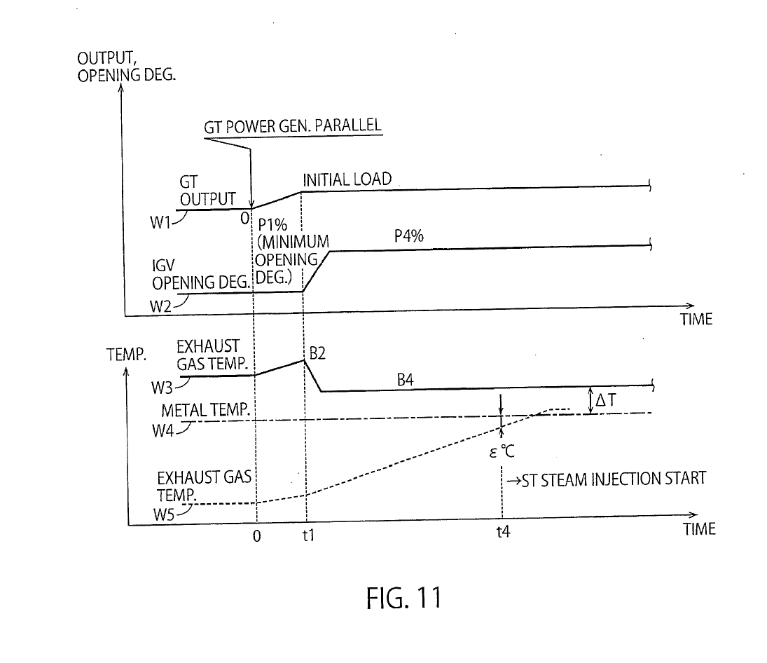

FIG. 11 is a graph for explaining the plant control method in the first comparative example. The plant control method illustrated in FIG. 11 is executed according to the flow illustrated in FIG. 10.

When the GT power generator 16 is brought into the parallel operation, the GT output value starts increasing from zero toward the initial load (waveform W1). At this point, since the GT output value is smaller than the initial load, the SV value C1 of exhaust gas temperature is set at the setting value B2 in normal time. Therefore, the exhaust gas temperature starts increasing toward the setting value B2 (waveform W3), and the main steam temperature starts increasing (waveform W5). In addition, since the setting value B2 is generally a high temperature, the deviation C4 is kept at a negative value, and the IGV opening degree is kept at P1%, which is the minimum opening degree (waveform W2). In contrast, since cold start is performed in the present method, the metal temperature is a low (waveform W4).

When the GT output value reaches the initial load at a time point t1 (waveform W1), the SV value C1 of exhaust gas temperature is switched to the setting value B4 on startup. At this point, since the measured value B3 of metal temperature indicates a low temperature (waveform W4), the setting value B4 is generally a low temperature. For this reason, the deviation C4 becomes a positive value, and the IGV opening degree starts increasing from P1% toward P4% (waveform W2). As a result, the exhaust gas temperature starts decreasing toward the setting value B4 (waveform W3), but the main steam temperature keeps increasing (waveform W5).

Afterward, the main steam temperature gradually increases, and the magnitude of the deviation between main steam temperature and the metal temperature reaches ε at a time point t4 (waveform W5). Thereupon, the plant control apparatus 2 opens the regulating valve 33 at the time point t4 to start the steam injection of the steam turbine 31.

In this comparative example, the increase in the main steam temperature from the time point t1 to the time point t4 is slow. Therefore, it takes a long time from the parallel operation of the GT power generator 16 to the start of the steam injection of the steam turbine 31. Therefore, it is desirable to shorten the starting time of the power plant 1.

### Second Comparative Example

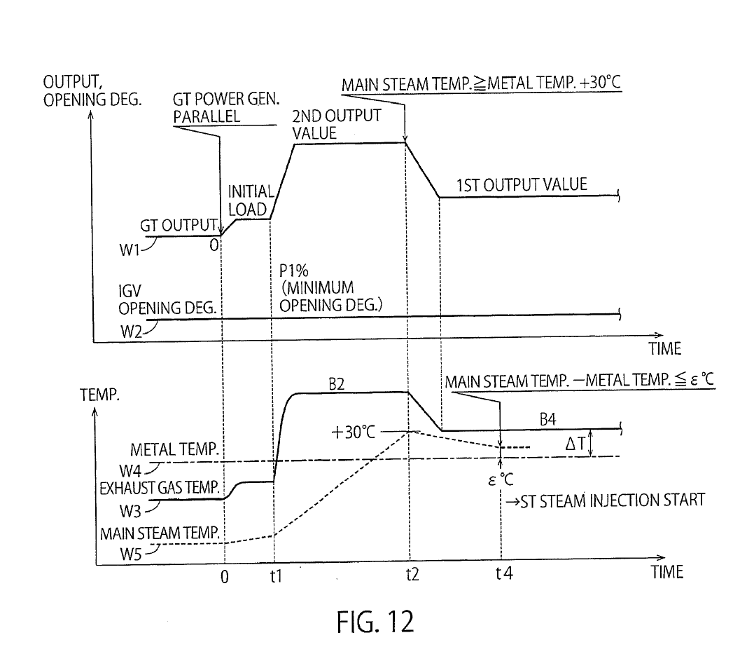

FIG. 12 is a graph for explaining a plant control method in a second comparative example. This comparative example will be described using reference characters and the like used in the description of the first comparative example, as appropriate.

Exhaust gas temperature in this comparative example (waveform W3) is adjusted not by controlling the IGV opening degree (waveform W2) but by controlling the GT output value (waveform W1). In FIG. 12, the IGV opening degree is kept at P1%, which is the minimum opening degree.

FIG. 12 illustrates, as the GT output value, the initial load, the first output value larger than the initial load, and a second output value larger than the first output value. The first output value is an output value that can keep the exhaust gas temperature at the metal temperature+ΔT when the IGV opening degree is P1%.

The plant control apparatus 2 can keep the exhaust gas temperature to the metal temperature+ΔT by controlling the GT output value to the first output value. In addition, the plant control apparatus 2 can keep the exhaust gas temperature higher than the metal temperature+ΔT by controlling the GT output value to the second output value. The GT output value is controlled by the output controller 56.

The graph illustrated in FIG. 12 will be described below in detail.

When the GT power generator 16 is brought into the parallel operation, the GT output value starts increasing from zero toward the initial load (waveform W1). This also causes the exhaust gas temperature to start increasing (waveform W3). Furthermore, the main steam temperature also starts increasing (waveform W5).

The output controller 56 switches the setting value of GT output value at the time point t1. Therefore, the GT output value starts increasing from the initial load toward the second output value at the time point t1 (waveform W1). As a result, the exhaust gas temperature increases to a temperature higher than the metal temperature+ΔT (waveform W3). Meanwhile, the main steam temperature keeps increasing (waveform W5).

When the main steam temperature reaches the metal temperature+30° C. at a time point t2 (waveform W5), the output controller 56 switches the setting value of GT output value. Therefore, the GT output value starts decreasing from the second output value toward the first output value at the time point t2 (waveform W1). As a result, the exhaust gas temperature decreases to the metal temperature+ΔT (waveform W3). In addition, the main steam temperature starts decreasing (waveform W5).

Afterward, the main steam temperature gradually decreases, and the magnitude of the deviation between the main steam temperature and the metal temperature reaches ε at the time point t4 (waveform W5). Thereupon, the plant control apparatus 2 opens the regulating valve 33 at the time point t4 to start the steam injection of the steam turbine 31.

In this comparative example, by setting the GT output value at a value as high as the second output value, it is possible to make the increase in the main steam temperature from the time point t1 to the time point t2 steep. This configuration enables the starting time of the power plant 1 to be shortened.

In addition, in this comparative example, the mismatch between the main steam temperature and the metal temperature is reduced by switching the GT output value from the second output value to the first output value. However, this mismatch is reducible by other methods. Examples of such methods will be described in a first and a second embodiment.

### First Embodiment

FIG. 1 is a schematic diagram illustrating a configuration of a power plant 1 in a first embodiment.

The plant control apparatus 2 in the present embodiment includes, in place of the setter 46 and the comparator 47, a setter 61, an adder 62, and a comparator 63.

The setter 61 holds a setting value (30° C.) of temperature difference between the main steam temperature and the metal temperature. The adder 62 acquires the measured value B3 of metal temperature from the metal temperature sensor 37 and acquires the setting value of temperature difference from the setter 61. Then, the adder 62 adds the setting value of temperature difference to the measured value B3 of metal temperature and outputs B3+30° C., which is a setting value D2 of main steam temperature.

The comparator 63 acquires a measured value D1 of main steam temperature from the main steam temperature sensor 38 and acquires the setting value D2 of main steam temperature from the adder 62. Then, the comparator 63 compares the measured value D1 of main steam temperature and the setting value D2 and outputs a switching signal D3, which corresponds to the result of the comparison.

The switcher 51 acquires the setting value B2 of exhaust gas temperature in normal time from the function generator 41, acquires the setting value B4 of exhaust gas temperature on startup from the lower limiter 45, and outputs the SV value C1 of exhaust gas temperature in accordance with the switching signal D3 from the comparator 63.

The indication of the switching signal D3 changes according to whether or not a measured value D1(X) of main steam temperature increases to a setting value D2(Y) and reaches the setting value D2(Y) (X≧Y). Before the measured value D1 reaches the setting value D2, the switcher 51 keeps the SV value C1 at the setting value B2 of exhaust gas temperature in normal time. On the other hand, when the measured value D1 reaches the setting value D2, the switcher 51 switches the SV value C1 to the setting value B4 for exhaust gas temperature on startup.

As seen from the above, when the measured value D1 of main steam temperature increases to the metal temperature+30° C., the switcher 51 switches the SV value C1 of exhaust gas temperature from the setting value B2 to the setting value B4. The setting value B2 is set following the function curve of the function generator 41. Meanwhile, the setting value B4 is normally set at the metal temperature+ΔT. The metal temperature+ΔT is an example of a first temperature depending on the metal temperature. The metal temperature+30° C. is an example of a second temperature that depends on the metal temperature.

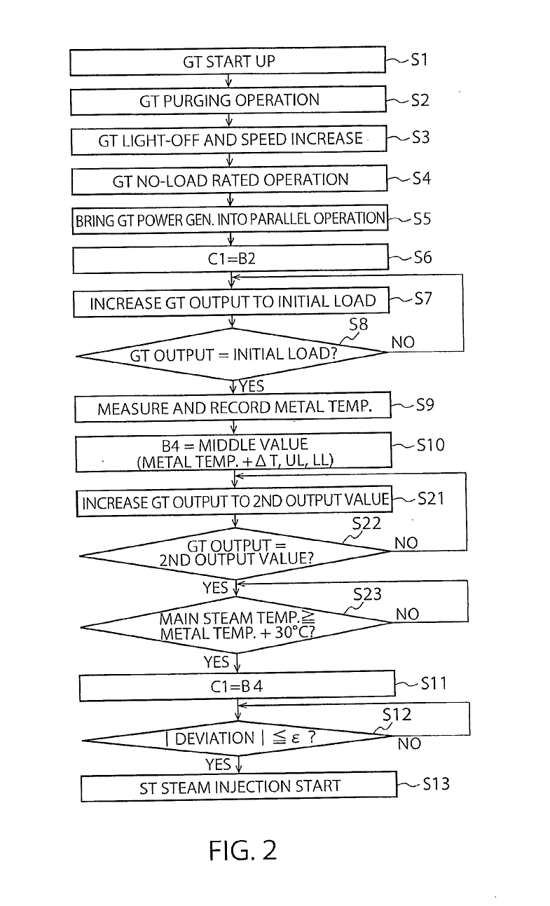

FIG. 2 is a flowchart illustrating a plant control method in the first embodiment.

The plant control method illustrated in FIG. 2 is executed on startup of the power plant 1 by the plant control apparatus 2. In the present method, it is assumed to perform cold start before which the operation of the power plant 1 has been suspended for a long time, and the metal temperature has been lowered to a low-temperature state.

When the gas turbine 14 is started up (step S1), and the gas turbine 14 is subjected to purging operation (step S2). Next, light-off of the gas turbine 14 is carried out and the speed of the gas turbine 14 increases (step S3), whereby the gas turbine 14 is brought into no-load rated operation (step S4).

Next, the GT power generator 16 is brought into parallel operation (step S5), and thereafter, the plant control apparatus 2 sets the setting value (SV value) C1 of exhaust gas temperature at the setting value B2 in normal time (step S6). As a result, the MV value C6 of IGV opening degree is kept to be a minimum opening degree. In addition, in order to avoid the disturbance of reverse power that the GT power generator 16 may suffer immediately after being brought into the parallel operation, the plant control apparatus 2 immediately increases the GT output value to the initial load (steps S7 and S8). Next, when the GT output value reaches the initial load, the plant control apparatus 2 acquires and stores the measured value B3 of metal temperature from the metal temperature sensor 37 (step S9).

Next, the plant control apparatus 2 uses the measured value B3 stored in step S9 to calculate the setting value B4 of exhaust gas temperature (=B3+ΔT). The gas turbine 14 cannot operate at extremely high or low exhaust gas temperatures, and therefore limits, the upper limit value UL and the lower limit value LL, are imposed on the setting value B4. Specifically, the setting value B4 is set at a middle value of B3+ΔT, UL, and LL (step S10).

In the phase of step S10, the setting value B4 is only calculated and not used as the SV value C1. In this phase, the SV value C1 is set at the setting value B2.

Next, the plant control apparatus 2 increases the GT output value from the initial load to the second output value (steps S21 and S22). The GT output value is thereafter kept at the second output value. As previously described, the second output value is a value larger than the first output value. The first output value is an output value that can keep the exhaust gas temperature at the metal temperature+ΔT when the IGV opening degree is the minimum opening degree. The minimum opening degree is an example of the first opening degree.

While the GT output value is kept at the second output value, the heat recovery steam generator 21 receives the exhaust gas A5 at high temperature so as to perform powerful heat recovery. As a result, the main steam temperature quickly increases.

Next, the plant control apparatus 2 determines whether or not the measured value D1 of main steam temperature is equal to or larger than the setting value D2 (step S23). The setting value D2 is calculated by adding 30° C. to the measured value B3 of metal temperature (D2=B3+30° C.). When the measured value D1 of main steam temperature increases to the setting value D2, the SV value C1 of exhaust gas temperature is switched to the setting value B4 on startup (step S11).

Since cold start is performed in the present method, the measured value B3 of metal temperature indicates a low temperature. For this reason, B3+ΔT is also a low temperature, and therefore the setting value B4 often assumes the lower limit value LL. Therefore, the SV value C1 of exhaust gas temperature is a low temperature, and the deviation C4 is a positive value. As a result, the MV value C6 of IGV opening degree increases from the minimum opening degree, and a PV value C3 of exhaust gas temperature decreases from the setting value B2 to the setting value B4.

This is the same as the first comparative example. However, while the GT output value in the first comparative example is kept at the initial load, the GT output value in the present embodiment is kept at the second output value. Therefore, the MV value C6 in the present embodiment is a value different from that in the first comparative example. In addition, while the GT output value in the second comparative example is switched from the second output value to the first output value, the GT output value in the present embodiment is kept at the second output value.

Keeping the GT output value at the second output value while keeping the exhaust gas temperature at the setting value B4 causes the main steam temperature to increase with time, so as to asymptotically approach the metal temperature. Therefore, the plant control apparatus 2 acquires the measured value D1 of main steam temperature from the main steam temperature sensor 38 and calculates the deviation between the measured value D1 of main steam temperature and the measured value B3 of metal temperature. Furthermore, the plant control apparatus 2 determines whether or not the absolute value of the deviation is equal to or less than ε (step S12).

Then, when the absolute value of the deviation becomes equal to or less than s, the plant control apparatus 2 opens a regulating valve 33 to start the steam injection of a steam turbine 31 (step S13). The steam turbine 31 is started up in such a manner. On the other hand, when the absolute value of the deviation becomes larger than ε, the plant control apparatus 2 put itself on standby for starting the steam injection of the steam turbine 31.

Afterward, the startup process of the power plant 1 is continued as in the first comparative example.

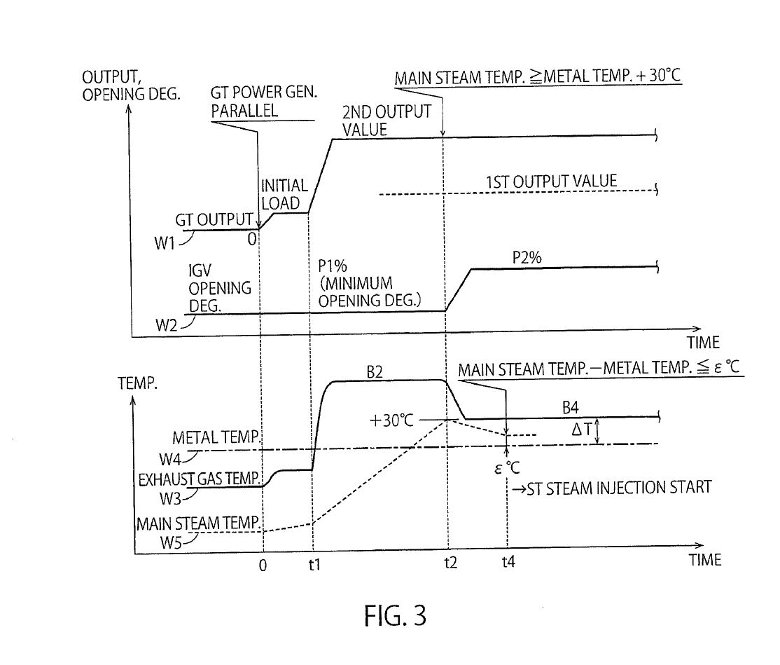

FIG. 3 is a graph for explaining the plant control method in the first embodiment. The plant control method illustrated in FIG. 3 is executed according to the flow illustrated in FIG. 2.

When the GT power generator 16 is brought into the parallel operation, the GT output value starts to increase from zero toward the initial load (waveform W1). This also causes the exhaust gas temperature to start increasing (waveform W3). At this point, since the measured value D1 of main steam temperature is less than the setting value D2, the SV value C1 of exhaust gas temperature is set at the setting value B2 in normal time. In addition, since the setting value B2 is generally a high temperature, the deviation C4 is kept at a negative value, and the IGV opening degree is kept at P1%, which is the minimum opening degree (waveform W2). In contrast, since cold start is performed in the present method, the metal temperature is low (waveform W4).

The output controller 56 switches the setting value of GT output value at the time point t1. Therefore, the GT output value starts increasing from the initial load toward the second output value at the time point t1 (waveform W1). As a result, the exhaust gas temperature increases to the setting value B2 metal temperature+ΔT) (waveform W3). Meanwhile, the main steam temperature keeps increasing (waveform W5).

When the main steam temperature reaches the metal temperature+30° C. at the time point t2 (waveform W5), the SV value C1 of exhaust gas temperature is switched to the setting value B4 on startup. At this point, since the measured value B3 of metal temperature indicates a low temperature (waveform W4), the setting value B4 is generally a low temperature. For this reason, the deviation C4 becomes a positive value, and the IGV opening degree starts increasing from P1% toward P2% (waveform W2). As a result, the exhaust gas temperature decreases to the setting value B4 (=metal temperature+ΔT) (waveform W3). In addition, the main steam temperature starts decreasing (waveform W5). The opening degree P1% is an example of the first opening degree, and the opening degree P2% is an example of a second opening degree. The opening degree P1% or P2% is an opening degree that allows the exhaust gas temperature to be kept at the metal temperature+ΔT when the GT output value is the first output value or the second output value, respectively, and the degrees of opening P1% and P2% satisfy the relation of P1%<P2%. The GT output value is kept at the second output value also from the time point t2 on (waveform W1).

Afterward, the main steam temperature decreases, and the magnitude of the deviation between the main steam temperature and the metal temperature reaches ε at the time point t4 (waveform W5). Thereupon, the plant control apparatus 2 opens the regulating valve 33 at the time point t4 to start the steam injection of the steam turbine 31.

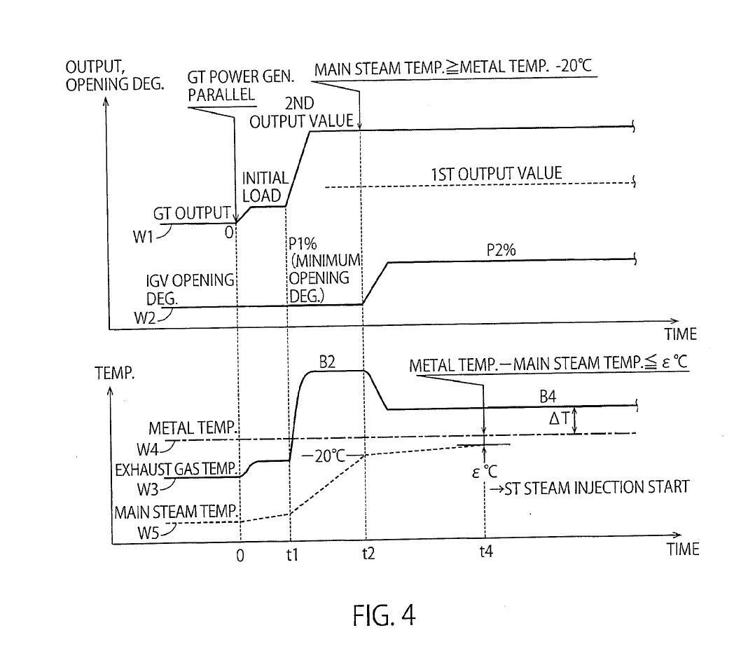

FIG. 4 is a graph for explaining a plant control method in a modification of the first embodiment.

FIG. 3 illustrates that the setting value D2 of main steam temperature is given by adding 30° C. to the measured value B3 of metal temperature (D2=B3+30° C.). In contrast, FIG. 4 illustrates that the setting value D2 of main steam temperature is given by subtracting 20° C. from the measured value B3 of metal temperature (D2=B3−20° C.). As seen from the above, the setting value D2 of main steam temperature may be either higher or lower than the measured value B3 of metal temperature.

Note that the condition of D2=B3+30° C. is assumed in the following description, but the following description is also applicable to the cases of D2>B3 and D2<B3.

Referring again to FIG. 1 to FIG. 3, the plant control method in the present embodiment will be described in detail.

In the first comparative example, the GT output value reaches the initial load and thereafter is kept at the initial load. In contrast, the GT output value in the present embodiment reaches the initial load and thereafter is caused to increase to the second output value such that the exhaust gas temperature is made even higher so as to facilitate a quick increase of the main steam temperature (steps S21 and S22). This second output value is desirably set at a maximum output value that is applicable before the steam injection of the steam turbine 31 so as to considerably shorten the starting time of the power plant 1.

For example, the maximum output value is set as follows. The second output value is desirably as large as possible to facilitate a quick increase of the main steam temperature. However, the power plant 1 in steps S21 and S22 is in such a particular state that the steam turbine 31 has not been subjected to the steam injection although the gas turbine 14 is in light-off operation. Therefore, it is desirable to limit the second output value limited taking into consideration the opening degree of the bypass control valve 34, the temperature difference in circulating water A8 between the inlet and the outlet of the condenser 32, the heat resistance of a heat exchanger in the heat recovery steam generator 21, and the like. Therefore, the maximum output value is set by calculating the second output value satisfying this limit.

While the GT output value is kept at the second output value, the main steam temperature quickly increases. However, if the steam turbine 31 is subjected to the steam injection with main steam at extremely high temperature, an excessively high thermal stress occurs in the steam turbine 31. Therefore, at an appropriate timing, the plant control apparatus 2 switches the SV value C1 of exhaust gas temperature from the setting value B2 to the setting value B4 (steps S23 and S11). For example, when the main steam temperature increases to the metal temperature+30° C., the plant control apparatus 2 in the present embodiment switches the SV value C1 of exhaust gas temperature. This configuration reduces the mismatch between the main steam temperature and the metal temperature. With this configuration, steam injection into the steam turbine 31 produces the main steam A6 at which a thermal stress occurring in the steam turbine 31 is low, which is preferable.

The main steam temperature in the present embodiment overshoots the metal temperature, a target temperature, by 30° C. (see FIG. 3). However, when the SV value C1 of exhaust gas temperature is switched from the setting value B2 to the setting value B4, the main steam temperature quickly decreases toward the metal temperature.

Now, a comparison will be made between the present embodiment and the first comparative example. In the first comparative example, since the exhaust gas temperature is kept at low temperature for a long time, the main steam temperature slowly increases, which takes a long time from the parallel operation of the GT power generator 16 to the start of the steam injection of the steam turbine 31 (FIG. 11). In contrast, in the present embodiment, the main steam temperature quickly increases to the metal temperature+30° C., and thereafter, it takes an extra asymptotically approaching time for causing the main steam temperature to decrease to the metal temperature+ε° C. (FIG. 3). However, even with the extra asymptotically approaching time taken, the time t4 up to the start of the steam injection in the present embodiment is shorter than the time t4 up to the start of the steam injection in the first comparative example. Therefore, according to the present embodiment, it is possible to shorten the starting time of the power plant 1.

As seen from the above, the plant control apparatus 2 in the present embodiment controls the IGV opening degree to P1% (minimum opening degree) during the period between the startup of the gas turbine 14 to the startup of the steam turbine 31 and controls the GT output value to the second output value. In addition, during this period, the plant control apparatus 2 in the present embodiment causes the IGV opening degree to increase from P1% to P2% based on the main steam temperature and the metal temperature while keeping the GT output value at the second output value.

Therefore, according to the present embodiment, by controlling the GT output value to the second output value, it is possible to shorten the starting time of the combined-cycle power plant 1 including the gas turbine 14, the heat recovery steam generator 21, and the steam turbine 31. In addition, according to the present embodiment, by causing the IGV opening degree to increase from P1% to P2% while keeping the GT output value at the second output value, it is possible to reduce the mismatch between the main steam temperature and the metal temperature by a method different from the method in the second comparative example.

### Second Embodiment

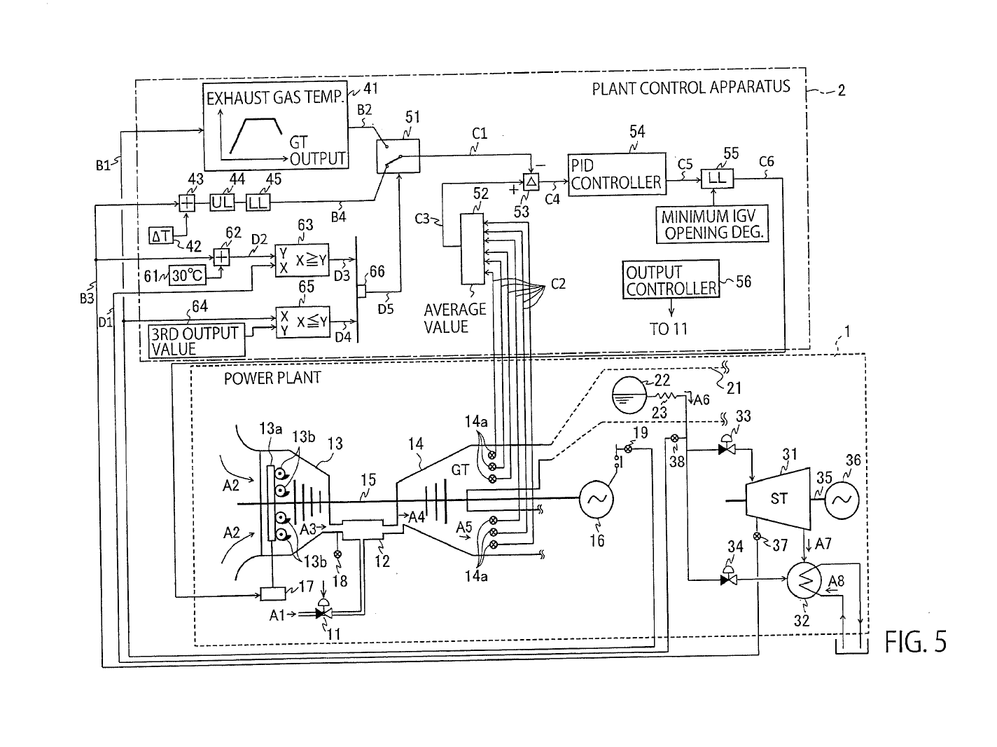

FIG. 5 is a schematic diagram illustrating a configuration of a power plant 1 in a second embodiment.

The plant control apparatus 2 in the present embodiment includes, in addition to the components of the plant control apparatus 2 in the first embodiment, a setter 64, a comparator 65, and an AND operator (AND gate) 66.

The setter 64 holds the setting value of a third output value of GT output value (hereafter, simply referred to as a third output value). The third output value is a value smaller than the second output value and larger than first output value.

The comparator 65 acquires the measured value B1 of GT output value from the output sensor 19 and acquires the third output value from the setter 64. Then, the comparator 65 compares the measured value B1 of GT output value with the third output value and outputs a switching signal D4, which corresponds to the result of the comparison.

The AND operator 66 acquires the switching signal D3 from the comparator 63, acquires the switching signal D4 from the comparator 65, and outputs a switching signal D5, which corresponds to the result of an AND operation on the switching signal D3 and the switching signal D4. Hereafter, the switching signals D3, D4, and D5 will be referred to a first, a second, and a third switching signal, respectively.

The switcher 51 acquires the setting value B2 of exhaust gas temperature in normal time from the function generator 41, acquires the setting value B4 of exhaust gas temperature on startup from the lower limiter 45 and outputs the SV value C1 of exhaust gas temperature in accordance with the third switching signal D5 from the AND operator 66.

Here, the indication of the first switching signal D3 changes according to whether or not the measured value D1(X) of main steam temperature increases to the setting value D2(Y) and reaches the setting value D2(Y) (X≧Y). The setting value D2 is given, as described above, by adding 30° C. to the measured value B3 of metal temperature (D2=B3+30° C.). In addition, the indication of the second switching signal D4 changes according to whether or not the measured value B1(X) of GT output value decreases to a third output value (Y) and reaches the third output value (Y) (X≦Y). In addition, the indication of the third switching signal D5 is the AND value of the indication of the first switching signal D3 and the indication of the second switching signal D4.

Therefore, in the case where the measured value D1 of main steam temperature has not reached the setting value D2, or the measured value B1 of GT output value has not reached the third output value, the switcher 51 keeps the SV value C1 at the setting value B2 of exhaust gas temperature in normal time. In contrast, in the case where the measured value D1 of main steam temperature has reached the setting value D2, and the measured value B1 of GT output value has reached the third output value, the switcher 51 switches the SV value C1 to the setting value B4 of exhaust gas temperature on startup.

As seen from the above, when the measured value D1 of main steam temperature increases to the metal temperature+30° C., and the GT output value decreases to the third output value, the switcher 51 switches the SV value C1 of exhaust gas temperature from the setting value B2 to the setting value B4. The setting value B2 is set following the function curve of the function generator 41. Meanwhile, the setting value B4 is normally set at the metal temperature+ΔT. The metal temperature+ΔT is an example of the first temperature depending on the metal temperature. The metal temperature+30° C. is an example of the second temperature depending on the metal temperature.

As will be described, when the measured value D1 of main steam temperature increases to the metal temperature+30° C., the plant control apparatus 2 in the present embodiment causes the GT output value to decrease from the second output value toward the third output value. Afterward, when the measured value B1 of GT output value reaches the third output value, the measured value D1 of main steam temperature has reached the metal temperature+30° C., which satisfies the AND condition of the AND operator 66. As a result, the SV value C1 of exhaust gas temperature is switched from the setting value B2 to the setting value B4.

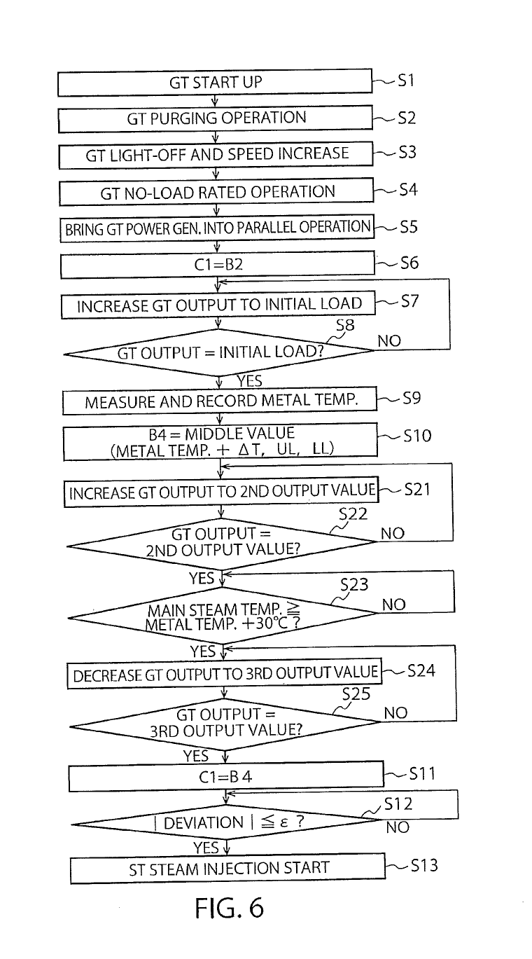

FIG. 6 is a flowchart illustrating a plant control method in the second embodiment.

The plant control method illustrated in FIG. 6 is executed on startup of the power plant 1 by the plant control apparatus 2. In the present method, it is assumed to perform cold start before which the operation of the power plant 1 has been suspended for a long time, and the metal temperature has been lowered to a low-temperature state.

When the gas turbine 14 is started up (step S1), and the gas turbine 14 is subjected to purging operation (step S2). Next, light-off of the gas turbine 14 is carried out and the speed of the gas turbine 14 is increased (step S3), whereby the gas turbine 14 is brought into no-load rated operation (step S4).

Next, the GT power generator 16 is brought into parallel operation (step S5), and thereafter, the plant control apparatus 2 sets the setting value (SV value) C1 of exhaust gas temperature at the setting value B2 in normal time (step S6). As a result, the MV value C6 of IGV opening degree is kept to be the minimum opening degree. In addition, in order to avoid the disturbance of reverse power that the GT power generator 16 may suffer immediately after being brought into the parallel operation, the plant control apparatus 2 immediately increases the GT output value to the initial load (steps S7 and S8). Next, when the GT output value reaches the initial load, the plant control apparatus 2 acquires and stores the measured value B3 of metal temperature from the metal temperature sensor 37 (step S9).

Next, the plant control apparatus 2 uses the measured value B3 stored in step S9 to calculate the setting value B4 of exhaust gas temperature (=B3+ΔT). The gas turbine 14 cannot operate at extremely high or low exhaust gas temperatures, and therefore the limits, the upper limit value UL and the lower limit value LL, are imposed on the setting value B4. Specifically, the setting value B4 is set at a middle value of B3+ΔT, UL, and LL (step S10).

In the phase of step S10, the setting value B4 is only calculated and not used as the SV value C1. In this phase, the SV value C1 is set at the setting value B2.

Next, the plant control apparatus 2 increases the GT output value from the initial load to the second output value (steps S21 and S22). The GT output value is thereafter kept at the second output value. As previously described, the second output value is a value larger than the first output value. The first output value is an output value that can keep the exhaust gas temperature at the metal temperature+ΔT when the IGV opening degree is the minimum opening degree. The minimum opening degree is an example of the first opening degree.

While the GT output value is kept at the second output value, the heat recovery steam generator 21 receives the exhaust gas A5 at high temperature so as to perform powerful heat recovery. As a result, the main steam temperature quickly increases.

Next, the plant control apparatus 2 determines whether or not the measured value D1 of main steam temperature is equal to or larger than the setting value D2 (step S23). The setting value D2 is calculated by adding 30° C. to the measured value B3 of metal temperature (D2=B3+30° C.). When the measured value D1 of main steam temperature increases to the setting value D2, the plant control apparatus 2 causes the GT output value to decreases the second output value toward the third output value (step S24).

Next, the plant control apparatus 2 determines whether or not the measured value B1 of GT output value has decreased to the third output value (step S25). When the measured value B1 of GT output value has decreased to the third output value, the SV value C1 of exhaust gas temperature is switched to the setting value B4 on startup (step S11). The GT output value is thereafter kept at the third output value.

Since cold start is performed in the present method, the measured value B3 of metal temperature indicates a low temperature. For this reason, B3+ΔT is also a low temperature, and therefore the setting value B4 often assumes the lower limit value LL. Therefore, the SV value C1 of exhaust gas temperature is a low temperature, and the deviation C4 has a positive value. As a result, the MV value C6 of IGV opening degree increases from the minimum opening degree, and the PV value C3 of exhaust gas temperature decreases to the setting value B4.

This is the same as the first embodiment. However, while the GT output value in the first embodiment is kept at the second output value, the GT output value in the present embodiment is kept at the third output value. Therefore, the MV value C6 in the present embodiment is a value different from that in the first embodiment.

Keeping the GT output value at the third output value while keeping the exhaust gas temperature at the setting value B4 causes the main steam temperature to increase with time to asymptotically approach the metal temperature. Therefore, the plant control apparatus 2 acquires the measured value D1 of main steam temperature from the main steam temperature sensor 38 and calculates the deviation between the measured value D1 of main steam temperature and the measured value B3 of metal temperature. Furthermore, the plant control apparatus 2 determines whether or not the absolute value of the deviation is equal to or less than ε (step S12).

Then, when the absolute value of the deviation becomes equal to or less than c, the plant control apparatus 2 opens the regulating valve 33 to start the steam injection of the steam turbine 31 (step S13). The steam turbine 31 is started up in such a manner. On the other hand, when the absolute value of the deviation is larger than ε, the plant control apparatus 2 puts itself on standby for starting the steam injection of the steam turbine 31.

Afterward, the startup process of the power plant 1 is continued as in the first comparative example.

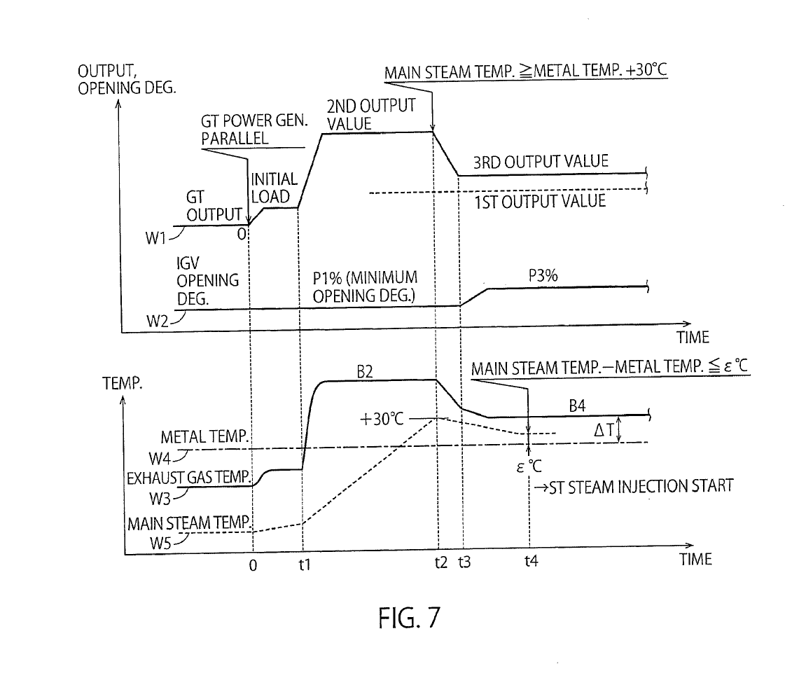

FIG. 7 is a graph for explaining the plant control method in the second embodiment. The plant control method illustrated in FIG. 7 is executed according to the flow illustrated in FIG. 6.

When the GT power generator 16 is brought into the parallel operation, the GT output value starts to increase from zero toward the initial load (waveform W1). This also causes the exhaust gas temperature to start increasing (waveform W3). Furthermore, the main steam temperature also starts increasing (waveform W5). At this point, since the measured value D1 of main steam temperature is less than the setting value D2, the SV value C1 of exhaust gas temperature is set at the setting value B2 in normal time. In addition, since the setting value B2 is generally a high temperature, the deviation C4 is kept at a negative value, and the IGV opening degree is kept at P1%, which is the minimum opening degree (waveform W2). In contrast, since cold start is performed in the present method, the metal temperature is low (waveform W4).

The output controller 56 switches the setting value of GT output value at the time point t1. Therefore, the GT output value starts increasing from the initial load toward the second output value at the time point t1 (waveform W1). As a result, the exhaust gas temperature increases to the setting value B2 metal temperature+ΔT) (waveform W3). Meanwhile, the main steam temperature keeps increasing (waveform W5).

When the main steam temperature reaches the metal temperature+30° C. at the time point t2 (waveform W5), the output controller 56 switches the setting value of GT output value. Therefore, the GT output value starts decreasing from the second output value toward the third output value at the time point t2 (waveform W1). This also causes the exhaust gas temperature to start decreasing (waveform W3). Furthermore, the main steam temperature also starts decreasing (waveform W5).

When the GT output value reaches the third output value at a time point t3 (waveform W1), the SV value C1 of exhaust gas temperature is switched to the setting value B4 on startup. At this point, since the measured value B3 of metal temperature indicates a low temperature (waveform W4), the setting value B4 is generally a low temperature. For this reason, the deviation C4 becomes a positive value, and the IGV opening degree starts increasing from P1% toward P3% (waveform W2). As a result, the exhaust gas temperature decreases to the setting value B4 (=metal temperature+ΔT) (waveform W3). Meanwhile, the main steam temperature keeps decreasing (waveform W5). The opening degree P1% is an example of the first opening degree, and the opening degree P3% is an example of a third opening degree. The opening degree P1%, P2%, or P3% is an opening degree that allows the exhaust gas temperature to be kept at the metal temperature+ΔT when the GT output value is the first output value, the second output value, or the third output value, respectively, and the degrees of opening P1%, P2%, and P3% satisfy the relation of P1%<P3%<P2%. This is attributed to the relation: first output value <third output value <second output value. The GT output value is kept at the third output value from the time point t3 on (waveform W1).

Afterward, the main steam temperature decreases, and the magnitude of the deviation between the main steam temperature and the metal temperature reaches c at the time point t4 (waveform W5). Thereupon, the plant control apparatus 2 opens the regulating valve 33 at the time point t4 to start the steam injection of the steam turbine 31.

Referring again to FIGS. 5 to 7, the plant control method in the present embodiment will be described in detail.

In general, the gas turbine 14 as commercial equipment has a wide range of models. Some models of the gas turbine 14 have a constraint on the upper limit of IGV opening degree in some cases. For example, when the fuel A1 is burned with the compressed air A3 in the combustor 12, the mixing ratio (fuel-air ratio) between the fuel A1 and the compressed air A3 needs to be appropriately kept. Meanwhile, when the IGV opening degree is caused to increase to increase the flow rate of the compressed air A3, the fuel-air ratio decreases. In this case, when the fuel-air ratio is an extremely low, the fuel A1 becomes too thin to keep combustion. Therefore, in order to avoid such a situation, the upper limit constraint is provided on the IGV opening degree in some cases.

In the first embodiment, the IGV opening degree is caused to increase from P1% to P2%. In this case, P2%, a high opening degree, can violate the constraint on the upper limit of IGV opening degree. For example, when the IGV opening degree increases from P1% to P2% to exceed the upper limit, there is the risk of failing to keep the combustion in the combustor 12 and causing a flame off.

For this reason, in the present embodiment, the GT output value is caused to decrease from the second output value to the third output value before the IGV opening degree is caused to increase from P1% to P3%. According to the present embodiment, by replacing the opening degree P2% with the opening degree P3%, it is possible to avoid an IGV opening degree in excess of the upper limit while causing the IGV opening degree to increase from P1%.

In the present embodiment, while the GT output value is kept at the second output value, the main steam temperature quickly increases. This is the same as the first embodiment. However, if the steam turbine 31 is subjected to the steam injection with main steam at extremely high temperature, an excessively high thermal stress occurs in the steam turbine 31. Therefore, at an appropriate timing, the plant control apparatus 2 switches the GT output value from the second output value to the third output value (steps S23 and S24). For example, when the main steam temperature increases to the metal temperature+30° C., the plant control apparatus 2 in the present embodiment switches the GT output value from the second output value to the third output value. Furthermore, when the GT output value decreases to the third output value, the plant control apparatus 2 in the present embodiment switches the SV value C1 of exhaust gas temperature from the setting value B2 to the setting value B4 (steps S25 and S11). This configuration reduces a mismatch between the main steam temperature and the metal temperature. With this configuration, steam injection into the steam turbine 31 produces the main steam A6 at which a thermal stress occurring in the steam turbine 31 is low, which is preferable.

[Comparison between Second Embodiment and First Embodiment]

Next, a comparison will be made between the second embodiment and the first embodiment.

As previously described, the third output value is smaller than the second output value. Therefore, in regard to the exhaust gas temperature immediately before the SV value C1 of exhaust gas temperature is switched from the setting value B2 to the setting value B4, the exhaust gas temperature in the second embodiment is lower than the exhaust gas temperature in the first embodiment. This corresponds to the fact that the exhaust gas temperature at the time point t3 in FIG. 7 is lower than the exhaust gas temperature at the time point t2 in FIG. 3.

When the IGV opening degree increases, the flow rate of the compressed air A3 at low temperature to be mixed with the combustion gas A4 at high temperature increases, which causes the exhaust gas temperature to decrease. For this reason, the lower the exhaust gas temperature before the mixture, the smaller the amount of a compressed air flow necessary to obtain a predetermined exhaust gas temperature. Therefore, in regard to the process of causing the exhaust gas temperature to decrease to the setting value B4, the amount of a compressed air flow necessary to cause the exhaust gas temperature to decrease to the setting value B4 from the time point t3 in FIG. 7 is smaller than the amount of a compressed air flow necessary to cause the exhaust gas temperature to decrease to the setting value B4 from the time point t2 in FIG. 3. As a result, the opening degree P3% in the second embodiment is lower than the opening degree P2% in the first embodiment.

Therefore, according to the second embodiment, it is possible to suppress a decrease in the fuel-air ratio with an increase in the IGV opening degree. As a result, it is possible to solve or mitigate the previously described problem in that the fuel A1 is too thin to keep combustion.

[Comparison Between Second Embodiment and Second Comparative Example]

Next, a comparison will be made between the second embodiment and the second comparative example.

The plant control apparatus 2 in the second embodiment causes the GT output value to decrease from the second output value to the third output value and thereafter switches the SV value C1 of exhaust gas temperature from the setting value B2 to the setting value B4. At this point, since the measured value B3 of metal temperature indicates a low temperature, the setting value B4 is generally a low temperature. For this reason, the deviation C4 becomes a positive value, and the IGV opening degree increases from P1% to P3%.

Now, in the plant control apparatus 2 in the second embodiment, assume the case where the third output value in the setting value in the setter 64 is replaced with the first output value. This corresponds to the case where the IGV opening degree is allowed to change in the second comparative example.

In this case, the plant control apparatus 2 causes the GT output value to decrease from the second output value to the first output value and thereafter switches the SV value C1 of exhaust gas temperature from the setting value B2 to the setting value B4. At this point, the exhaust gas temperature has already reached the setting value B4 (=metal temperature+ΔT). The reason for this is that the first output value is an output value that can keep the exhaust gas temperature at the metal temperature+ΔT when the IGV opening degree is P1%. Therefore, when the GT output value is caused to decrease from the second output value to the first output value, the PV value C3 of exhaust gas temperature decreases to the setting value B4. Therefore, when the SV value C1 of exhaust gas temperature is switched from the setting value B2 to the setting value B4, the deviation C4 between the SV value C1 and the PV value C3 becomes zero. Therefore, the IGV opening degree is kept at P1%.

As seen from the above, even when the IGV opening degree is allowed to change in the second comparative example, the IGV opening degree is kept at P1% as illustrated in FIG. 12.

Next, a comparison will be made between FIG. 7 (second embodiment) and FIG. 12 (second comparative example).

As previously described, for the GT output value, the relation: third output value >first output value holds. Meanwhile, for the IGV opening degree, the relation: P3%>P1% (minimum opening degree) holds.

Comparing the case where the GT output value in FIG. 7 is the third output value and the case where the GT output value in FIG. 12 is the first output value, the exhaust gas temperature becomes the setting value B4 (=metal temperature+ΔT) in both cases, but the IGV opening degree differs between both cases. That is, the opening degree in the case illustrated in FIG. 7 changes to P3%, whereas the opening degree in the case illustrated in FIG. 12 is kept at P1%. As a result, the amount of the compressed air flow in the case illustrated in FIG. 7 is larger than the amount of the compressed air flow in the case illustrated in FIG. 12.

Therefore, in the case where the GT output value in FIG. 7 is the third output value, the flow rate of the exhaust gas A5 received by the heat recovery steam generator 21 is high as compared with the case where the GT output value in FIG. 12 is the first output value, and therefore the flow rate of the main steam A6 generated by the heat recovery steam generator 21 is high (meanwhile, the temperature of the main steam A6 is the same in both cases).

As seen from the above, according to the second embodiment, by causing the GT output value to decrease not to the first output value but to the third output value, it is possible to increase the flow rate of the main steam A6. A large amount of the main steam A6 generated after the start of the steam injection of the steam turbine 31 allows for quick progress of the subsequent startup process of the power plant 1. An example of such a case will be described below.

As previously described, after the start of the steam injection of the steam turbine 31, the startup process of the power plant 1 is continued as follows. On the steam turbine 31, an increase of the speed of the steam turbine 31, the parallel operation of the ST power generator 36, an increase of the output of the steam turbine 31 to the initial load, initial load heat soak of the steam turbine 31, and a further increase of the output of the steam turbine 31 are performed in this order.

At this point, according to the second embodiment, with a large amount of main steam A6, it is possible to proceed this series of the startup process without a hitch. In contrast, in the second comparative example, there is the risk that the flow rate of the main steam A6 runs short, which makes the startup process sluggish, in performing the parallel operation of the ST power generator 36, or in increasing the output of the steam turbine 31 to the initial load. In this case, the second comparative example needs, for example, such a measure that waits for an increase in the flow rate of the main steam A6 with time (resulting in a prolonged starting time), or such a measure that causes the GT output value to increase from the first output value, trading off the reduction in the thermal stress in the steam turbine 31 to some extent

[Consideration on Second Embodiment]

Next, the consideration on the second embodiment will be described.

The exhaust gas temperature of the gas turbine 14 is reducible by, for example, the following two methods. A first method is to cause the GT output value to decrease. A second method is to cause the IGV opening degree to increase. The second comparative example employs the first method. The first comparative example and the first embodiment employ the second method. The second embodiment employs the first and the second method.

In performing the cold start of the power plant 1, an increase in the thermal stress in the steam turbine 31 becomes a problem. At this point, it is difficult in some cases to sufficiently reduce the exhaust gas temperature only by a decrease in the GT output value or only by an increase in the IGV opening degree.

For example, the GT output value is so limited that the GT output value cannot decrease to less than the initial load. This means that the previously described first output value or third output value is set at a value larger than the initial load. Furthermore, this means that the initial load is a minimum output that allows the operation of the power plant 1 to continue while avoiding reverse power.

In light of the recent technological trends, the gas turbine 14 has been oriented toward increasing capacity and performance, and a combustion temperature (gas turbine inlet temperature) in the combustor 12 tends to increase, and the exhaust gas temperature also tends to increase. Therefore, in regard to the gas turbine 14, it can be assumed that models discharging exhaust gas at temperatures as high as about 500° C., even in an initial load state, become mainstream. In this case, it is considered that a sufficient reduction of the exhaust gas temperature becomes difficult only by a decrease in the GT output value.

To deal with this problem, using both of the first and the second method as in the second embodiment can be considered to be a rational approach. This is because using both of the first and the second method allows a constraint imposed on one of the methods to be eliminated or mitigated by the other method.

However, in the case of using both of the first and the second method as in the second embodiment, it is demanded to optimize the contribution and the assignment of the first method and the second method. Specifically, it is demanded to select a suitable third output value.

For example, selecting an excessively large third output value may lead to the following problems (1) and (2) on the IGVs 13b.

(1) An excessively large third output value makes the IGV opening degree have a large. However, when the IGV opening degree becomes large, a decrease in the fuel-air ratio between the fuel A1 and the compressed air A3 becomes a problem. An excessively low fuel-air ratio has the risk that combustion cannot be kept.

(2) In order to reduce nitrogen oxides (NOx) in the exhaust gas A5 as part of environmental measures, a low NOx combustor using premix combustion may be employed as the combustor 12. In this case, a complex, high combustion technology is required as compared with a combustor using a conventional diffusion combustion. For this reason, such a third output value that causes the IGV opening degree to extremely increase to increase the amount of air flow cannot also be employed from this viewpoint.

On the other hand, selecting an excessively low third output value may lead to the following problem (3).

(3) An excessively low third output value has, as in the second comparative example, the risk that the amount of a main steam flow necessary to drive the steam turbine 31 cannot be secured sufficiently.

It is demanded to set the third output value at such a well-balanced value that can avert these problems (1), (2), and (3). For example, in the case where one gas turbine 14 and one steam turbine 31 are arranged on different shaft in FIG. 5, the third output value is conceivably set at an output that is 8% to 15% with respect to 100% rated output (base load) of the gas turbine 14. However, it is demanded that the selection of a suitable third output value is in conformity with various design of the gas turbine 14.

As seen from the above, the plant control apparatus 2 in the present embodiment controls the IGV opening degree to P1% (minimum opening degree) during the period between the startup of the gas turbine 14 to the startup of the steam turbine 31 and controls the GT output value to the second output value or the third output value. In addition, the plant control apparatus 2 in the present embodiment causes the IGV opening degree to increase from P1% to P3% based on the GT output value during this period. Specifically, the plant control apparatus 2 causes the GT output value to decrease from the second output value to the third output value based on the main steam temperature and the metal temperature before causing the IGV opening degree to increase from P1% to P3% while keeping the GT output value at the third output value.

Consequently, according to the present embodiment, by controlling the GT output value to the second output value, it is possible to shorten the starting time of the combined-cycle power plant 1 including the gas turbine 14, the heat recovery steam generator 21, and the steam turbine 31. In addition, according to the present embodiment, by causing the GT output value to decrease from the second output value to the third output value before causing the IGV opening degree to increase from P1% to P3%, it is possible to reduce the mismatch between the main steam temperature and the metal temperature by a method different from the method in the second comparative example. In addition, according to the present embodiment, by setting the third output value at a suitable value higher than the first output value, it is possible to secure a sufficient amount of a main steam flow.

While certain embodiments have been described, these embodiments have been presented by way of example only, and are not intended to limit the scope of the inventions. Indeed, the novel apparatuses, methods and plants described herein may be embodied in a variety of other forms; furthermore, various omissions, substitutions and changes in the form of the apparatuses, methods and plants described herein may be made without departing from the spirit of the inventions. The accompanying claims and their equivalents are intended to cover such forms or modifications as would fall within the scope and spirit of the inventions.

1. A plant control apparatus configured to control a power plant comprising:
a combustor configured to burn fuel with oxygen introduced from an inlet guide vane to generate a gas;
a gas turbine configured to be driven by the gas from the combustor;
a heat recovery steam generator configured to generate steam using heat of an exhaust gas from the gas turbine; and
a steam turbine configured to be driven by the steam from the heat recovery steam generator,
the apparatus comprising:
an opening controller configured to control an opening degree of the inlet guide vane to a first opening degree within a period from start of the gas turbine to start of the steam turbine; and
an output controller configured to control an output value of the gas turbine to a value larger than a first output value within the period from the start of the gas turbine to the start of the steam turbine, the first output value being an output value at which a temperature of the exhaust gas can be kept at a first temperature that depends on a metal temperature of the steam turbine, when the opening degree of the inlet guide vane is the first opening degree,
the opening controller being configured to increase the opening degree of the inlet guide vane from the first opening degree based on a temperature of the steam or the output value of the gas turbine, while the output controller controls the output value of the gas turbine to the value larger than the first output value.

2. The apparatus of claim 1, wherein
the output controller is configured to control the output value of the gas turbine to a second output value larger than the first output value within the period from the start of the gas turbine to the start of the steam turbine,
the opening controller is configured to increase the opening degree of the inlet guide vane from the first opening degree to a second opening degree based on the temperature of the steam and the metal temperature, while the output controller controls the output value of the gas turbine to the second output value, and
the second opening degree is an opening degree that allows the temperature of the exhaust gas to be kept at the first temperature, when the output value of the gas turbine is the second output value.

3. The apparatus of claim 2, wherein the opening controller is configured to increase the opening degree of the inlet guide vane from the first opening degree to the second opening degree, when the temperature of the steam reaches a second temperature that depends on the metal temperature.

4. The apparatus of claim 1, wherein
the output controller is configured to control the output value of the gas turbine to a second output value larger than the first output value within the period from the start of the gas turbine to the start of the steam turbine,
the output controller is configured to decrease the output value of the gas turbine from the second output value to a third output value based on the temperature of the steam and the metal temperature within the period from the start of the gas turbine to the start of the steam turbine,
the opening controller is configured to increase the opening degree of the inlet guide vane from the first opening degree to a third opening degree, when the output value of the gas turbine reaches the third output value, and
the third opening degree is an opening degree that allows the temperature of the exhaust gas to be kept at the first temperature, when the output value of the gas turbine is the third output value.

5. The apparatus of claim 4, wherein the output controller is configured to decrease the output value of the gas turbine from the second output value to the third output value, when the temperature of the steam reaches a second temperature that depends on the metal temperature.

6. The apparatus of claim 3, wherein the second temperature is a temperature higher than the metal temperature.

7. The apparatus of claim 3, wherein the second temperature is a temperature lower than the metal temperature.

8. A plant control method of controlling a power plant comprising:
a combustor configured to burn fuel with oxygen introduced from an inlet guide vane to generate a gas;
a gas turbine configured to be driven by the gas from the combustor;
a heat recovery steam generator configured to generate steam using heat of an exhaust gas from the gas turbine; and
a steam turbine configured to be driven by the steam from the heat recovery steam generator,
the method comprising:
controlling an opening degree of the inlet guide vane to a first opening degree within a period from start of the gas turbine to start of the steam turbine;
controlling an output value of the gas turbine to a value larger than a first output value within the period from the start of the gas turbine to the start of the steam turbine, the first output value being an output value at which a temperature of the exhaust gas can be kept at a first temperature that depends on a metal temperature of the steam turbine, when the opening degree of the inlet guide vane is the first opening degree; and
increasing the opening degree of the inlet guide vane from the first opening degree based on a temperature of the steam or the output value of the gas turbine, while controlling the output value of the gas turbine to the value larger than the first output value.

9. A power plant comprising:
a combustor configured to burn fuel with oxygen introduced from an inlet guide vane to generate a gas;
a gas turbine configured to be driven by the gas from the combustor;
a heat recovery steam generator configured to generate steam using heat of an exhaust gas from the gas turbine;
a steam turbine configured to be driven by the steam from the heat recovery steam generator;
an opening controller configured to control an opening degree of the inlet guide vane to a first opening degree within a period from start of the gas turbine to start of the steam turbine; and
an output controller configured to control an output value of the gas turbine to a value larger than a first output value within the period from the start of the gas turbine to the start of the steam turbine, the first output value being an output value at which a temperature of the exhaust gas can be kept at a first temperature that depends on a metal temperature of the steam turbine, when the opening degree of the inlet guide vane is the first opening degree,
the opening controller being configured to increase the opening degree of the inlet guide vane from the first opening degree based on a temperature of the steam or the output value of the gas turbine, while the output controller controls the output value of the gas turbine to the value larger than the first output value.
